(19) United States
(12) Patent Application Publication
(10) Pub. No.: US 2024/0125592 A1
(43) Pub. Date: Apr. 18, 2024

(54) BEAM MEASURING DEVICE, SAMPLE PROCESSOR AND METHOD OF MEASURING BEAM

(71) Applicant: Beckman Coulter Biotechnology (Suzhou) Co., Ltd., Suzhou (CN)

(72) Inventors: Wei SHI, Suzhou (CN); Ruifeng MIAO, Suzhou (CN); Zhonghui CHEN, Suzhou (CN); Jianhua WANG, Suzhou (CN)

(73) Assignee: Beckman Coulter Biotechnology (Suzhou) Co., Ltd., Suzhou (CN)

(21) Appl. No.: 18/356,674

(22) Filed: Jul. 21, 2023

(30) Foreign Application Priority Data
Jul. 28, 2022 (CN) 202210902030.6

(51) Int. Cl. G01B 11/24; G01B 11/26

(52) U.S. Cl. CPC G01B 11/2433; G01B 11/26

(57) ABSTRACT

The present disclosure relates to a beam measuring device, a sample processor including the beam measuring device, and a method of measuring a beam using the beam measuring device. The beam measuring device includes a detection unit and a light impediment unit. The light impediment unit is located between the detection unit and a light source, and is configured to generate a shadow area on the detection unit by blocking transmission of part of a beam coming from the light source. The detection unit is configured to measure the shadow area, and to determine whether the beam is divergent or inclined with respect to a predetermined optical axis based on the measurement of the shadow area. The beam measuring device may shorten the optical detection channel and ensure the detection accuracy, thereby having a compact structure. In addition, the beam measuring device may measure divergence angle and directionality, respectively.

### CROSS-REFERENCE TO RELATED APPLICATION(S)

This application claims priority to Chinese Patent Application No. 202210902030.6, filed on Jul. 28, 2022, the disclosure of which is hereby incorporated by reference in its entirety.

### FIELD

The present disclosure relates to a beam measuring device, and in particular to a beam measuring device for sample processor. The present disclosure further relates to a sample processor such as a flow cytometer/analyzer including a beam measuring device. The present disclosure further relates to a method of measuring a beam using the beam measuring device.

### BACKGROUND

This section only provides background information related to the present disclosure, which is not necessarily the prior art.

In an optical system, beams emitted from a light source often need to be collimated before reaching the target. The collimated beam shall have desired characteristics to ensure the precision or accuracy of the optical system. These characteristics include divergence characteristics (e.g., the degree to which the beam contracts or diverges along the direction of propagation) and directionality characteristics (e.g., the degree of inclination of the parallel beam relative to the predetermined optical axis). For this purpose, a beam measuring device is provided for detecting the divergence and directionality characteristics of the collimated beam.

The existing beam measuring device directly measures the beam, that is, measures some parameters of the beam itself. In such a beam measuring device and method, the beam measuring path is long to ensure measurement accuracy, resulting in a larger size of the beam measuring device. For a system with limited space, the beam measuring device and method are disadvantageous.

In addition, due to the above-mentioned structural limitations, the measurement of divergence angle and directionality is often integrated in the same measurement device and performed simultaneously. This increases measurement difficulty and complexity.

### SUMMARY

A general summary of the present disclosure is provided in this section, rather than the full scope of the present disclosure or a comprehensive disclosure of all features of the present disclosure.

In view of the above problems of the existing beam measuring devices, an object according to the present disclosure is to provide a beam measuring device and method, which may shorten the optical detection channel while ensuring the detection accuracy, so that the beam measuring device has a compact structure. In an embodiment, the beam measuring device and method may independently detect the divergence angle or directionality of the beam as required, thereby simplifying the detection process and improving the detection accuracy.

According to an aspect of the present application, a beam measuring device is provided, which includes a detection unit and a light impediment unit. The light impediment unit is located between the detection unit and a light source, and is configured to generate a shadow area on the detection unit by blocking transmission of part of a beam coming from the light source. The detection unit is configured to measure the shadow area, and to determine whether the beam is divergent or inclined with respect to a predetermined optical axis based on the measurement of the shadow area.

According to the beam measuring device of the present disclosure, the shadow area is generated by the light impediment unit and the divergence property or directionality property of the beam is indirectly determined based on the measurement of the shadow area. The indirect measurement by the light impediment unit may shorten the optical detection channel of the beam, so that the size of the beam measuring device can be reduced. The arrangement of the light impediment unit can be changed according to the need, which is more flexible and can be applied to various occasions.

In some embodiments according to the present disclosure, the detection unit is configured to calculate a divergence angle of the beam or an inclined angle of the beam relative to the predetermined optical axis based on the measurement of the shadow area.

In some embodiments according to the present disclosure, the light impediment unit includes a first light impediment and a second light impediment. The first light impediment and the second light impediment are arranged and spaced apart in a first direction perpendicular to the predetermined optical axis, and the first and second light impediments create a first shadow area and a second shaded region on the detection unit, respectively. The detection unit is configured to measure the first shadow area and the second shadow area, and to calculate an inclined angle of the beam relative to the predetermined optical axis based on difference of the measurements of the first shadow area and the second shadow area and sizes of the first and second light impediments in a second direction parallel to the predetermined optical axis.

In some embodiments according to the present disclosure, the first light impediment and/or the second light impediment comprises two column-shaped members which are arranged in such a way that they are offset from each other in both the first direction and the second direction.

In some embodiments according to the present disclosure, the first light impediment and the second light impediment have the same configuration and are arranged symmetrically with respect to the second direction.

In some embodiments according to the present disclosure, the light impediment unit includes at least one light impediment, and the detection unit is configured to measure a shadow area generated by a single light impediment of the at least one light impediment, and to calculate a divergence angle of the beam based on the measurement of the shadow area and a distance between the light impediment and the detection unit.

In some embodiments according to the present disclosure, the light impediment is a column-shaped member.

In some embodiments according to the present disclosure, the beam measuring device further includes an actuation means configured to translate the light impediment unit and/or the detection unit relative to the light source.

In some embodiments according to the present disclosure, the beam measuring device includes multiple light-impediment units with different configurations, and the detection unit includes multiple detectors for detecting the light-impediment units, respectively.

A sample processor is provided according to another aspect of the present disclosure. The sample processor includes the above-mentioned beam measuring device.

According to yet another aspect of the present disclosure, there is provided a method of measuring a beam using the above-mentioned beam measuring device. The method includes: measuring the shadow area generated by the light impediment unit on the detection unit; and determining whether the beam is divergent or inclined with respect to the predetermined optical axis based on the measurement of the shaded area.

In some embodiments according to the present disclosure, the method further includes calculating a divergence angle of the beam or an inclined angle of the beam with respect to the predetermined optical axis based on the measurement of the shadow area.

In some embodiments according to the present disclosure, the method further includes: translating the light impediment unit and/or the detection unit relative to the light source.

The above and other objects, features and advantages of the present disclosure will be more fully understood from the detailed description given below and the accompanying drawings, which are given by way of illustration only and therefore, are not considered to limit the present disclosure.

### BRIEF DESCRIPTION OF THE DRAWINGS

The features and advantages of one or more embodiments of the present disclosure will become more readily understood from the following description with reference to the accompanying drawings. In the drawings:

FIG. 1 is a schematic perspective view of a beam measuring device according to a first embodiment of the present disclosure;

FIG. 2 is a schematic perspective view showing an internal structure of the beam measuring device of FIG. 1, wherein a part of the casing is removed;

FIG. 3 is a schematic longitudinal cross-sectional view of the beam measuring device of FIG. 1 cut along the beam propagation direction;

FIG. 4 is a cross-sectional schematic diagram of the beam measuring device of FIG. 1 cut along an optical detection channel;

FIG. 5A is an optical schematic diagram of a situation in which the beam measuring device of FIG. 4 detects divergence characteristics;

FIG. 5B is another optical schematic diagram of a situation in which the beam measuring device of FIG. 4 detects divergence characteristics;

FIG. 5C is another optical schematic diagram of a situation in which the beam measuring device of FIG. 4 detects divergence characteristics;

FIG. 6 is a schematic perspective view of a beam measuring device according to a second embodiment of the present disclosure;

FIG. 7 is a schematic longitudinal cross-sectional view of the beam measuring device of FIG. 6 cut along the beam propagation direction;

FIG. 8 is a cross-sectional schematic diagram of the beam measuring device of FIG. 6 cut along an optical detection channel;

FIG. 9 is a schematic top view of the beam measuring device of FIG. 6, wherein the top cover of the casing is removed;

FIG. 10 is an optical schematic diagram of the beam measuring device of FIG. 8 for detecting directionality characteristics; and

FIG. 11 is a flowchart of a method of measuring a beam using a beam measuring device according to the present disclosure.

### DETAILED DESCRIPTION OF THE EMBODIMENTS

The following detailed description of the present disclosure is for explanation only and is by no means intended to limit the present disclosure and the applications or usages thereof. The implementations described in this specification are not exhaustive and are merely some of many possible implementations. Exemplary embodiments may be embodied in many different forms and should not be construed as limitation to the scope of the present disclosure. In some exemplary embodiments, well-known processes, well-known device structures, and well-known technologies may not be described in detail.

The beam measuring device and method according to the present disclosure is suitable for detecting characteristics of a beam, in particular, divergence characteristics or directionality characteristics thereof. The beam measuring device and method according to the present disclosure is suitable for detecting the divergence property or the directionality property individually as required. As used herein, “beam divergence” refers to beam reduction or expansion, not collimation. In other words, the diverging beam has a varying diameter rather than a constant diameter. “Directionality of the beam” as used herein refers to the orientation or tilt of the beam relative to the desired optical axis.

The beam measuring device and method according to the present disclosure are suitable for various optical detection systems, e.g., optical detection systems for sample processors. For example, the optical system and sample processor are used for detection or sorting of liquid samples containing biological particles (e.g., extracellular vesicles) or non-biological particles (e.g., beads).

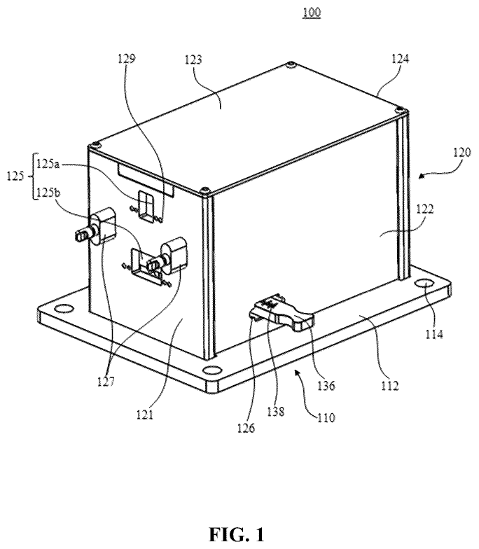

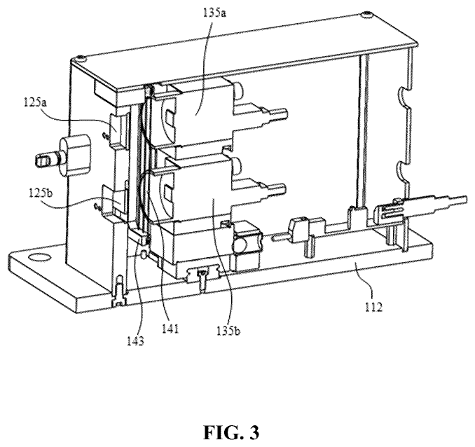

The beam measuring device 100 according to the first embodiment of the present disclosure will be described below with reference to FIGS. 1 to 5C. The beam measuring device 100 is adapted to detect the divergence characteristics of the beam. In several drawings, similar reference numerals refer to similar parts and components.

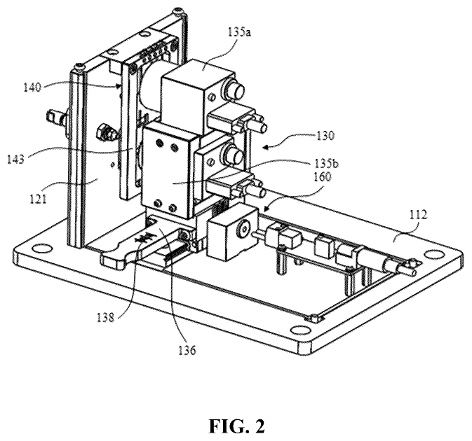

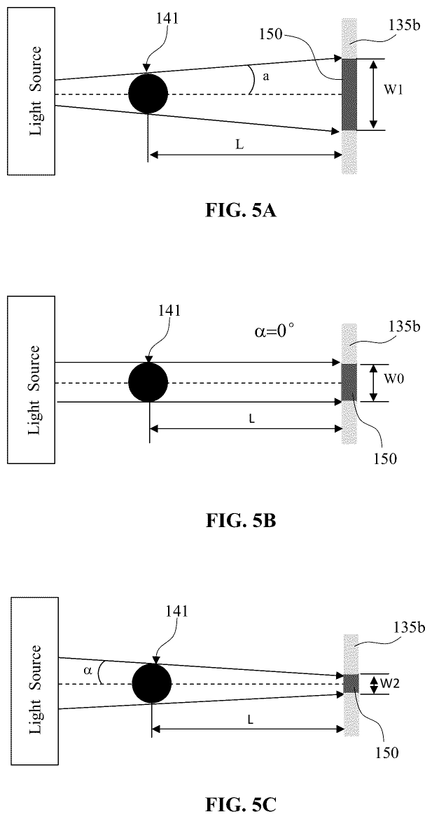

FIG. 1 is a schematic perspective view of a beam measuring device 100 according to a first embodiment of the present disclosure. FIGS. 2 to 4 are a schematic diagram of an internal structure, a schematic diagram of a longitudinal section, and a schematic diagram of a transverse section of the beam measuring device 100, respectively. FIGS. 5A to 5C are optical schematic diagrams of various situations in which the beam measuring device 100 detects divergence characteristics.

As shown in FIGS. 1 to 4, the beam measuring device 100 includes a mounting base 110, a casing 120 fixed to the mounting base 110, a detection unit 130 and a light impediment unit 140 provided in the casing 120. The mounting base 110 is used for fixedly mounting the beam measuring device 100 to a fixed structure of a system or instrument to which the beam measuring device 100 is applied. The casing 120 is used for accommodating the detection unit 130 and (optionally) the light impediment unit 140, so as to detect the beam. The light impediment unit 140 is located between the detection unit 130 and a light source (not shown), and is configured to generate a shadow area on the detection unit 130 by blocking part of the beam. The detection unit 130 is used to receive the beam from the light source, measure the shadow area and determine some characteristics of the beam, such as divergence characteristics or directionality characteristics, based on the measurement results.

In the example shown in the figures, the mounting base 110 includes a plate-shaped body 112 and holes 114 for receiving fasteners such as bolts or screws. The plate-shaped body 112 is generally rectangular. The holes 114 are located at the four corners of the plate-shaped body 112. It should be understood that the structure of the mounting base described herein should not be limited to the specific examples shown in the figures, but may be changed as required, as long as the functions described herein can be implemented.

The casing 120 may be configured to provide support for at least a portion of the components of the beam measuring device 100, and to prevent or reduce interference or influence on the beam detection caused by the surrounding environment. In the example shown in the figure, the casing 120 has a cuboid shape and includes a front cover 121, two side covers 122, a top cover 123 and a rear cover 124. The mounting base 110 and the casing 120 define a space for accommodating the detection unit 130 and the light impediment unit 140 (optional). Therefore, the mounting base 110 may also be regarded as a bottom cover of the casing 120.

The casing 120 is provided with an opening 125 that allows the beam to pass through to reach the detection unit 130. In the example shown in the figure, a first opening 125a and a second opening 125b are provided on the front cover 121 of the casing 120. The first opening 125a corresponds to the first detector 135a of the detection unit 130 and forms a first optical detection channel or path with the first detector 135a. The second opening 125b corresponds to the second detector 135b of the detection unit 130 and forms a second optical detection channel or path with the second detector 135b. The first optical detection channel and the second optical detection channel may have the same or different configurations, and may be selected according to detection needs. The first detector 135a and the second detector 135b may be CCD detectors or any other suitable detectors known in the art. The first detector 135a and the second detector 135b may be the same or different.

In the example shown in the figures, both the first opening 125a and the second opening 125b have a rectangular shape, but have different aspect ratios and dimensions. It should be understood that the number, shape, and size of the openings 125 may vary according to needs, for example, depending on the beam to be detected, the light impediment unit, and/or the detector.

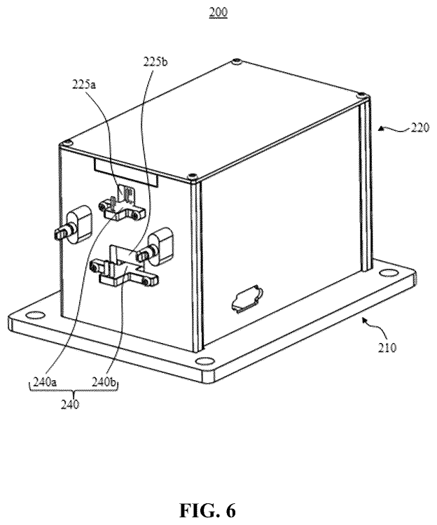

Various mounting or fastening structures 127, 129 may be provided on the casing 120 for mounting or fastening various components or units of the beam measuring device 100, for example, the light impediment unit 140. The mounting or fastening structure 127 or the mounting or fastening structure 129 may be selected according to different light impediment units 140. In the examples shown in FIGS. 1 to 4, the mounting or fastening structure 127 is used to mount or fasten the light impediment unit 140 suitable for detecting divergence characteristics. In the examples shown in FIGS. 6 to 9, the mounting or fastening structure 129 is used to mount or fasten a light impediment unit 240 (which will be described later) suitable for detecting directionality characteristics.

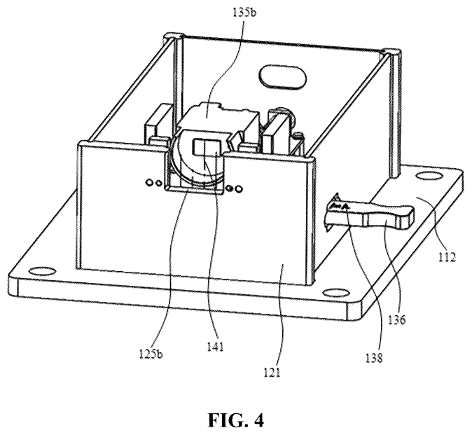

In the examples shown in FIGS. 1 to 4, the light impediment unit 140 is configured to detect the divergence property of the beam. The light impediment unit 140 includes multiple light impediments 141. The beam measuring device according to the present disclosure may detect the divergence property of the beam using a single light impediment 141. However, according to the size of the beam, multiple light impediments 141 may be provided. For example, the larger the size of the beam, the more light impediments 141 (four light impediments are shown in FIG. 4) can be provided to detect different parts of the beam, thereby realizing comprehensive detection and evaluation of the beam.

The light impediment unit 140 further includes a frame 143. The frame 143 is used to carry or mount the light impediment 141. As shown, the frame 143 has a generally rectangular shape, and multiple light impediments 141 are arranged in parallel in the frame 143 in the form of a fence. The multiple light impediments 141 are arranged in parallel along the detection direction, whereby the beam can be comprehensively detected and evaluated in the desired detection direction. The detection direction can be determined as required. The light impediments 141 may have the same structure, or may have different structures (e.g., different sizes). The light impediments 141 may be spaced apart at the same pitch, or may be spaced apart at different pitches.

Each light impediment 141 is in the form of a columnar member. The columnar light impediment 141 extends perpendicular to the detection direction. In the examples shown in FIGS. 4 and 5A to 5C, the detection direction is the horizontal direction, and the single light impediment 141 extends in the vertical direction. It should be understood that the structure and arrangement of the light impediment 141 are not necessarily limited to the specific examples shown in the drawings, but may vary, for example, depending on the detection purpose, detection accuracy, and the like.

In the examples shown in FIGS. 1 to 4, each cylindrical light impediment 141 extends across the first opening 125a and the second opening 125b (i.e., the first optical detection channel and the second optical detection channel). In other words, the light impediment units 140 in the first and second optical detection channels are integrated. However, it should be understood that the light impediment units 140 in the first and second optical detection channels may have different structures or arrangements, and/or may also be independent of each other.

The beam detection device 100 may further include an actuation means 160 for translating the detection unit 130 (detectors 135a and 135b) relative to the light source. The actuation means 160 may have any suitable structure for translating the detection unit 130 known to those skilled in the art. For example, when the beam size is large and the area of the detector of the detection unit 130 is small, the detector can be translated by the actuation means 160, so that the performance of different positions of the beam can be more comprehensively evaluated. It should be understood that the actuation means may also translate the light blocking member 141 to detect or evaluate the performance of the desired position of the beam.

The detection unit 130 may include an indicating rod 136 that translates with the detector. The indicating rod 136 may have a mark 138 for indicating the translational position of the detector. Accordingly, the casing 120 may be provided with an opening or window 126 for viewing the mark 138.

Referring to FIGS. 5A to 5C, the optical detection principle of detecting the divergence characteristics of beams with the beam measuring device 100 will be described below, taking the single light impediment 141 in the second optical detection channel shown in FIG. 4 as an example.

Referring to FIG. 5A, the light impediment 141 of the beam measuring device 100 is light-opaque, so that a shadow area 150 is generated on the detector 135b. The light impediment 141 has a diameter D and is a distance L from the detector 135b (i.e., the distance between the center of the light impediment 141 and the detection surface of the detector 135b is L). The shadow area 150 has a width W1 in the detection direction (horizontal direction in the figure).

By comparing the size (e.g., width) of the shadow area 150 with the size (e.g., diameter) of the light impediment 141, the divergence of the beam can be determined. In FIG. 5A, the width W1 of the shadow area 150 is greater than the diameter D of the light impediment 141, which means that the beams are not completely parallel, but gradually expand. In FIG. 5B, the width W0 of the shadow area 150 is substantially equal to the diameter D of the light impediment 141, which means that the beams are parallel, that is, the divergence angle is 0 degrees. In FIG. 5C, the width W2 of the shadow area 150 is smaller than the diameter D of the light impediment 141, which means that the beams are not completely parallel, but tapered.

Further, after measuring the width W of the shadow area 150 (e.g., W1 in FIG. 5A, W0 in FIG. 5B, or W2 in FIG. 5C), the divergence angle α can be calculated by the following formula: α=a tan(0.5*(W−D)/L). The diameter D and the distance L of the light impediment 141 can be set as required. In an example not shown, the beam measuring device 100 may further include means for adjusting the distance L, thereby making the beam measuring device 100 suitable for detection of various beams.

The beam measuring device 200 according to the second embodiment of the present disclosure will be described below with reference to FIGS. 6 to 10. The beam measuring device 200 is adapted to detect the directionality property of the beam. In several drawings, similar reference numerals refer to similar parts and components.

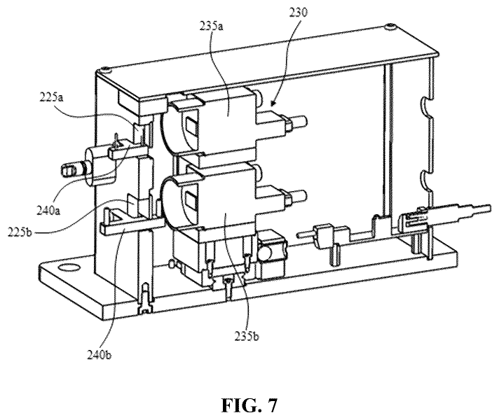

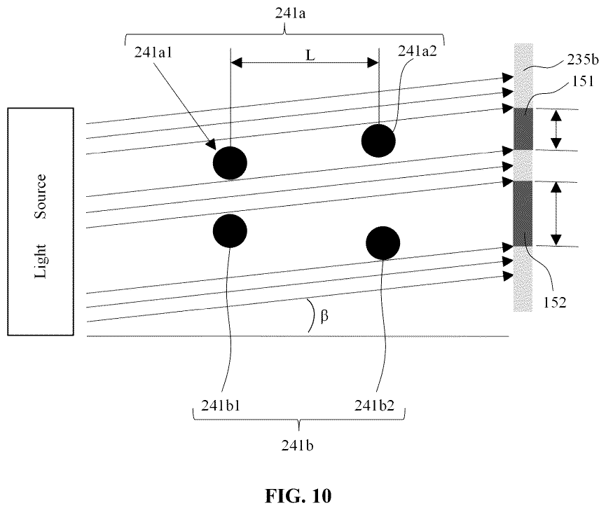

FIG. 6 is a schematic perspective view of a beam measuring device 200 according to a second embodiment of the present disclosure. FIGS. 7 to 9 are a schematic longitudinal section, a schematic transverse section and a schematic top view of the beam measuring device 200, respectively. FIG. 10 is an optical schematic diagram of the beam measuring device 200 for detecting directionality characteristics.

As shown in FIGS. 6 to 9, the beam measuring device 200 includes a mounting base 210, a casing 220 fixed to the mounting base 210, a detection unit 230 and a light impediment unit 240 provided in the casing 220. The structures of the mounting base 210, the casing 220 and the detection unit 230 are similar to those of the mounting base 110, the casing 120 and the detection unit 130, and thus are not described in detail. The structure of the light impediment unit 240 is significantly different from the structure of the light impediment unit 140. The light impediment unit 240 will be described in detail below with reference to FIGS. 6 to 9.

The light impediment unit 240 includes a first light impediment unit 240a and a second light impediment unit 240b. The first light impediment unit 240a is disposed in the first opening 225a of the casing 220. The first light impediment unit 240a corresponds to the first detector 235a of the detection unit 230 and forms a first optical detection channel or path with the first detector 235a. The second light impediment unit 240b is disposed in the second opening 225b of the casing 220. The second light impediment unit 240b serves corresponds to the second detector 235b of the detection unit 230 and forms a second optical detection channel or path with the second detector 235b.

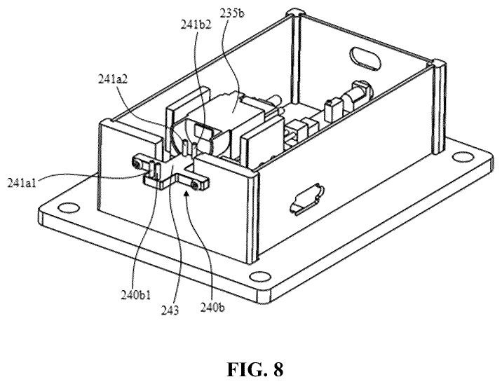

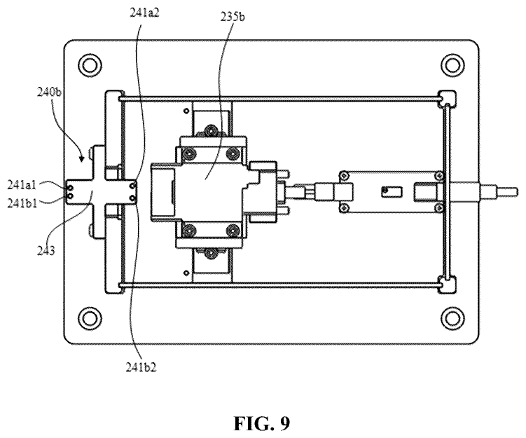

The first light impediment unit 240a and the second light impediment unit 240b have similar structures but different sizes. The structure of the second light impediment unit 240b will be described below with reference to FIGS. 8 and 9. Since the structures of the first light impediment unit 240a and the second light impediment unit 240b are similar, the description of the first light impediment unit 240a is omitted herein.

As shown in FIGS. 8 and 9, the second light impediment unit 240b includes a pair of columns 241a1 and 241b1 arranged parallel to and away from the second detector 235b, a pair of columns 241a2 and 241b2 arranged parallel to and adjacent to the second detector 235b, and a carrier 243 for carrying the columns. Along the beam transmission path, the column 241a1 corresponds to the column 241a2, and constitutes a first light impediment 241a with the column 241a2 (see FIG. 10). Along the beam transmission path, the column 241b1 corresponds to the column 241b2, and constitutes a second light impediment 241b with the column 241b2 (see FIG. 10).

As used herein, a “light impediment” refers to an opaque entity that creates a single complete, continuous shadow area on the detector for detection of beam characteristics. For example, in the examples shown in FIGS. 1 to 5C, each light impediment consists of a single column; in the examples shown in FIGS. 6 to 10, each light impediment consists of two columns. It should be understood that the structure of the light impediment according to the present disclosure is not limited to the specific example shown in the figures, but may vary as long as a shadow area can be generated to detect the characteristics of the beam.

The columns 241a1, 241a2, 241b1 and 241b2 are fixedly mounted on the carrier 243 which in turn is fixedly attached to the casing 220. Fasteners such as bolts or screws are inserted into the holes of the carrier 243 and the holes of the casing 220 (the mounting or fastening structure 129 shown in FIG. 1), thereby securing the carrier 243 to the casing 220. The carrier 243 has a cross-shaped body. It should be understood that the structure of the carrier 243 should not be limited to the specific examples shown in the figures, but may vary as long as the functions described herein are implemented.

The beam measuring device 200 shown in FIGS. 6 to 9 determines the directionality property of the beam through the mutual relationship between the shadow areas generated by the first light impediment and the second light impediment. Referring to FIG. 10, the optical detection principle of detecting the directionality characteristics of beams with the beam measuring device 200 will be described below, taking the second light impediment unit 240b shown in FIG. 8 as an example.

Referring to FIG. 10, the columns 241a1 and 241a2 are arranged offset from each other in a direction parallel to the predetermined optical axis (referred to as “optical axis direction” for convenience of description) and a direction perpendicular to the predetermined optical axis (referred to as “beam detection direction” for convenience of description). Similarly, the columns 241b1 and 241b2 are arranged offset from each other in both the optical axis direction and the beam detection direction. The columns 241a1 and 241a2 (i.e., the first light impediments 241a) and the columns 241b1 and 241b2 (i.e., the second light impediments 241b) are arranged symmetrically with respect to the optical axis direction. Each column has the same diameter D. The distance between the columns 241a1 (or 241b1) and 241a2 (or 241b2) in the optical axis direction (i.e., the distance between the centers of the two columns) is L.

The first light impediment 241a constituted by the columns 241a1 and 241a2 produces a first shadow area 151 on the second detector 235b. The second light impediment 241b constituted by the columns 241b1 and 241b2 produces a second shadow area 152 on the second detector 235b. The first light impediment 241a and the second light impediment 241b are arranged in parallel and spaced apart in the beam detection direction. Accordingly, the first shadow area 151 and the second shadow area 152 are spaced apart in the beam detection direction on the second detector 235b. The first shadow area 151 has a width W1 in the beam detection direction, and the second shadow area 152 has a width W2 in the beam detection direction.

Depending on the angle at which the beam is inclined relative to the direction of the predetermined optical axis, the size of the shadow area created by the light impediment may also vary. Therefore, the shadow area can be measured, and the directionality property of the beam (i.e., the angle by which the beam is inclined with respect to the predetermined optical axis direction) can be obtained based on the measurement result of the shadow area.

After measuring the widths W1 and W2, the inclination angle β of the beam can be calculated by the following formula: β=a tan(0.5*(W2−W1/L). If the beam transmission distance from the light source to the detector on the predetermined optical axis is known or measured to be L0, the directionality index ΔX can be calculated by the following formula: ΔX=L0*tan β.

It should be understood that the structures and arrangements of the first light impediment 241a and the second light impediment 241b are not necessarily limited to the specific examples shown in the figures, but can be changed as long as the functions described herein can be achieved.

Although the two embodiments of the beam measuring device according to the present disclosure have been described above with reference to FIGS. 1 to 10, it should be understood that the beam measuring device according to the present disclosure should not be limited to the specific examples shown in the figures, but may be changed as required. For example, additional components may be added to the beam measuring device as required. For example, an attenuation sheet is arranged in the beam detection channel or path.

The beam measuring device described above can be applied to a sample processor. Sample processing instruments are generally used to analyze liquid samples including small suspended particles (e.g., biological particles, non-biological particles) or cells and/or to sort the particles or cells therein. Laser diodes are often used as the light source for the optical detection system of the sample processor. Focusing the beam emitted from the laser diode into the detection channel of the flow cell of the sample processor. As particles or cells in the sample pass through the detection channel, they are illuminated by a beam, thus emitting fluorescent or scattered light for detection.

However, the divergence of laser diodes is large, so the beam emitted from the laser diode needs to be collimated. The characteristics of the collimated laser beam determine the accuracy and efficiency of the sample processor. Therefore, some characteristics of the laser beam are very important for the detection of samples. After the laser beam has been processed (e.g., collimated or shaped), the characteristics of the beam need to be measured to determine whether the beam can meet detection requirements. The sample processor to which the above-described beam detection device is applied can also have a compact structure due to the shortened detection path. Furthermore, by exchanging the light impediment units of different structures, the desired characteristics of the beams in the sample processor can be individually detected.

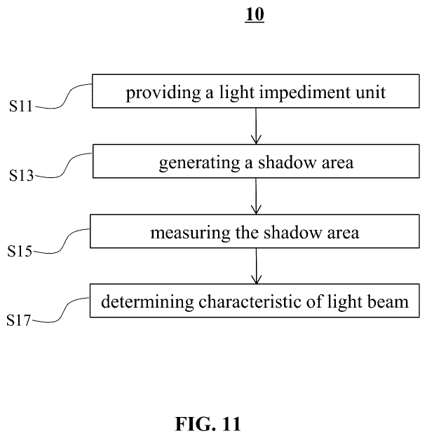

The beam measuring method 10 according to the present disclosure will be described below with reference to FIG. 11. FIG. 11 is a flowchart of a method 10 for measuring a beam using a beam measuring device according to the above.

Referring to FIG. 11, the method 10 first provides or selects a light impediment unit having a desired structure (step S11). The required structure depends on the characteristics of the beam to be measured, e.g., the divergence characteristics shown in FIGS. 5A to 5C and the directionality characteristics shown in FIG. 10. At step S13, the light source is turned on and a shadow area is created on the detector by means of the light impediment unit. Then, in step S15, the shadow area is measured, for example, the width of the shadow area in the beam detection direction is measured. At step S17, based on the measured value of the shadow area and the parameter value associated with the light impediment unit, the parameter value (e.g., divergence angle or tilt angle) representing the measured property of the beam is determined or calculated.

It should be understood that the method according to the present disclosure is not limited to the specific flowchart shown in FIG. 11, but can be changed as needed. For example, the step of adjusting the detector and/or light impediment, etc. may also be included.

Although the present application has been described with reference to exemplary embodiments, it should be understood that the present application is not limited to the specific embodiments described and illustrated herein. Without departing from the scope defined by the appended claims, those skilled in the art can make various changes to the exemplary embodiments. Provided that there is no contradiction, the features in the various embodiments can be combined with each other. Alternatively, a certain feature in the embodiment may also be omitted.

What is claimed is:

1. A beam measuring device, comprising:
a detection unit; and
a light impediment unit located between the detection unit and a light source, and configured to generate a shadow area on the detection unit by blocking transmission of part of a beam coming from the light source,
wherein the detection unit is configured to measure the shadow area, and to determine whether the beam is divergent or inclined with respect to a predetermined optical axis based on the measurement of the shadow area.

2. The beam measuring device according to claim 1, wherein the detection unit is configured to calculate a divergence angle of the beam or an inclined angle of the beam relative to the predetermined optical axis based on the measurement of the shadow area.

3. The beam measuring device according to claim 1, wherein the light impediment unit comprises a first light impediment and a second light impediment which are arranged and spaced apart in a first direction perpendicular to the predetermined optical axis, and wherein the first and second light impediments create a first shadow area and a second shaded region on the detection unit, respectively, and
wherein the detection unit is configured to measure the first shadow area and the second shadow area, and to calculate an inclined angle of the beam relative to the predetermined optical axis based on difference of the measurements of the first shadow area and the second shadow area and sizes of the first and second light impediments in a second direction parallel to the predetermined optical axis.

4. The beam measuring device according to claim 3, wherein the first light impediment and/or the second light impediment comprises two column-shaped members which are arranged in such a way that they are offset from each other in both the first direction and the second direction.

5. The beam measuring device of claim 4, wherein the first light impediment and the second light impediment have the same configuration and are arranged symmetrically with respect to the second direction.

6. The beam measuring device according to claim 1, wherein the light impediment unit comprises at least one light impediment, and the detection unit is configured to measure a shadow area generated by a single light impediment of the at least one light impediment, and to calculate a divergence angle of the beam based on the measurement of the shadow area and a distance between the light impediment and the detection unit.

7. The beam measuring device according to claim 6, wherein the light impediment is a column-shaped member.

8. The beam measuring device according to claim 6, further comprising an actuation means configured to translate the light impediment unit and/or the detection unit relative to the light source.

9. The beam measuring device according to claim 1, comprising a plurality of light-impediment units with different configurations, and the detection unit comprises a plurality of detectors for detecting the light-impediment units, respectively.

10. A sample processor comprising the beam measuring device according to claim 1.

11. A method of measuring a beam using the beam measuring device according to claim 1, comprising:
measuring the shadow area generated by the light impediment unit on the detection unit; and
determining whether the beam is divergent or inclined with respect to the predetermined optical axis based on the measurement of the shaded area.

12. The method according to claim 11, further comprising:
calculating a divergence angle of the beam or an inclined angle of the beam with respect to the predetermined optical axis based on the measurement of the shadow area.

13. The method according to claim 11, further comprising:
translating the light impediment unit and/or the detection unit relative to the light source.
